(19) United States
(12) Patent Application Publication
(10) Pub. No.: US 2026/0208555 A1
(43) Pub. Date: Jul. 23, 2026

(54) MOUNTING BRACKET ASSEMBLY FOR PROVIDING IMPACT PROTECTION, HEAT SHIELDING AND NOISE MITIGATION FOR VEHICLE ELECTRIC AIR CONDITIONING COMPRESSOR

(71) Applicant: FCA US LLC, Auburn Hills, MI (US)

(72) Inventors: Carlo V. Mercurio, Auburn Hills, MI (US); Kelly Chianetta, Auburn Hills, MI (US)

(21) Appl. No.: 19/033,846

(22) Filed: Jan. 22, 2025

(51) Int. Cl. B60H 1/00

(52) U.S. Cl. CPC B60H 1/00521

(57) ABSTRACT

A vehicle that includes a propulsion system, a high-voltage electric air conditioning compressor (EAC) unit attached to the propulsion system, and a mounting bracket assembly attached to the EAC unit in a manner where the EAC unit is at least partially sandwiched between the mounting bracket assembly and the propulsion system. The he mounting bracket assembly includes a protective shield that is configured to protect the EAC unit from being damaged during a vehicle collision event, and the mounting bracket assembly includes a polymeric insert that is configured to be sandwiched between the protective shield and the EAC unit and provide thermal shielding and noise attenuation.

### FIELD

The present disclosure relates to a mounting bracket assembly for providing impact protection, heat shielding, and noise mitigation for a vehicle electric air conditioning compressor.

### BACKGROUND

This section provides background information related to the present disclosure which is not necessarily prior art.

Vehicles are currently being manufactured that may include an internal combustion engine (ICE) drivetrain, a battery-powered drivetrain, or a combination of an ICE drivetrain and battery-powered drivetrain (i.e., hybrid). Because hybrid vehicles include a combination of an ICE drivetrain and a battery-powered drivetrain, hybrid vehicles can be much heavier in comparison to vehicles that include only an ICE drivetrain or a battery-powered drivetrain. This additional mass can lead to components of the hybrid vehicle being exposed to greater forces during a collision event.

Specifically, when some types of hybrid vehicles are subjected to high-speed driver side small overlap (DSORB) impact testing, there may be instances where the forces generated during such an impact are sufficient to cause the structure integrity of a housing of a high-voltage component of the hybrid vehicle to fail. If the housing of the high-voltage component fails, there is a potential for sharp edges to be formed that can damage the sensitive features of the high-voltage component located in the housing, which is undesirable. Regardless whether the vehicle contains a hybrid drivetrain, an ICE drivetrain, or an electrically-powered drivetrain, the fact remains that vehicles are increasingly incorporating a larger number of high-voltage components that require protection from damage during a collision event.

It should also be understood that to the extent that battery-powered vehicles and hybrid vehicles may operate without generating as much noise as a conventional ICE drivetrain, operation of various components in the engine compartment of the vehicle can generate noise that can be undesirably observed in a passenger cabin of the vehicle. There is a need, therefore, to mitigate the noise generated by these components in order to reduce the amount of noise that may be experienced by an occupant of the vehicle.

Lastly, it should be understood that components of the ICE can generate heat during operation thereof that can also potentially negatively affect operation of the high-voltage components. There is also a need, therefore, to mitigate subjecting the high-voltage components to the extensively hot under-hood temperatures that may be generated by the ICE and its components.

### SUMMARY

This section provides a general summary of the disclosure, and is not a comprehensive disclosure of its full scope or all of its features.

According to a first aspect of the present disclosure, there is provided a vehicle that may include a propulsion system; a high-voltage electric air conditioning compressor (EAC) unit attached to the propulsion system; and a mounting bracket assembly attached to the EAC unit in a manner where the EAC unit is at least partially sandwiched between the mounting bracket assembly and the propulsion system, wherein the mounting bracket assembly includes a protective shield that is configured to protect the EAC unit from being damaged during a collision event; and the mounting bracket assembly includes a polymeric insert that is configured to be sandwiched between the protective shield and the EAC unit.

According to the first aspect, the polymeric insert is configured to thermally shield the EAC unit.

According to the first aspect, the polymeric insert is configured to attenuate noise generated by the EAC unit.

According to the first aspect, the protective shield includes a first end, an opposite second end, and a primary panel that extends between and is unitary with each of the first end and opposite second end.

According to the first aspect, a first connection arm that is configured to attach the mounting bracket assembly to the propulsion system is attached to an upper edge of the primary panel and a second connection arm that is configured to attach the mounting bracket assembly to the propulsion system is attached to a lower edge of the primary panel.

According to the first aspect, the first connection arm includes an upstanding tab attached thereto having a first through-hole configured for receipt of a first fastener and the second connection arm includes an elongated tab having at least one second through-hole configured for receipt of a second fastener.

According to the first aspect, the upstanding tab includes a first aperture configured for receipt of a first clip.

According to the first aspect, the protective shield may also include a strut attached to the first end of the protective shield, the strut having a second aperture configured for receipt of a second clip.

According to the first aspect, the EAC unit includes a high-voltage cable attached thereto and oriented relative to the EAC unit by the second clip, and the EAC unit includes a low-voltage cable attached thereto and oriented relative to the EAC unit by the first clip.

According to the first aspect, the polymeric insert is formed of a polymeric foam.

According to the first aspect, the vehicle may also include an exhaust treatment component positioned proximate the EAC unit, wherein the mounting bracket assembly is configured to thermally shield the EAC unit from heat generated by the exhaust treatment component.

According to the first aspect, the protective shield includes an opening and the polymeric insert includes a recess that corresponds to an inlet or an outlet of the EAC unit.

According to the first aspect, the protective shield is formed of a rigid metal material.

According to the first aspect, the polymeric insert includes a first end section, an opposite second end section, and a primary body that extends between and is unitary with each of the first end section and opposite end section.

According to a second aspect of the present disclosure, there is provided a vehicle that may include an internal combustion engine; an exhaust treatment component in communication with the internal combustion engine; a high-voltage electric air conditioning compressor (EAC) unit attached to the internal combustion engine at a location proximate the exhaust treatment component; and a mounting bracket assembly attached to the EAC unit in a manner where the EAC unit is at least partially sandwiched between the mounting bracket assembly and the internal combustion engine, wherein the mounting bracket assembly includes a protective shield that is configured to protect the EAC unit from being damaged during a vehicle collision event; the mounting bracket assembly includes a polymeric insert that is configured to be sandwiched between the protective shield and the EAC unit; and the polymeric insert is configured to thermally shield the EAC unit from heat generated by the exhaust treatment component, and the polymeric insert is configured to attenuate noise generated by the EAC unit during operation thereof.

According to the second aspect, the protective shield includes a first end, an opposite second end, and a primary panel that extends between and is unitary with each of the first end and opposite second end.

According to the second aspect, a first connection arm that is configured to attach the mounting bracket assembly to the propulsion system is attached to an upper edge of the primary panel and a second connection arm that is configured to attach the mounting bracket assembly to the propulsion system is attached to a lower edge of the primary panel.

According to the second aspect, the first connection arm includes an upstanding tab attached thereto having a first through-hole configured for receipt of a first fastener and the second connection arm includes an elongated tab having at least one second through-hole configured for receipt of a second fastener.

According to the second aspect, the polymeric insert includes a first end section, an opposite second end section, and a primary body that extends between and is unitary with each of the first end section and opposite end section.

According to the second aspect, the polymeric insert is formed of a polymeric foam.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial overhead perspective view of a vehicle frame of a vehicle according to a principle of the present disclosure;

FIG. 2 is a partial overhead perspective of FIG. 1, after the vehicle has experienced a collision event;

FIG. 3 is a perspective view of a high-voltage electric air conditioning compressor (EAC) unit that may be damaged during the collision event illustrated in FIG. 2;

FIG. 4 is a perspective view of the EAC unit illustrated in FIG. 3 attached to a vehicle propulsion system and being protected by a mounting bracket assembly according to a principle of the present disclosure;

FIG. 5 is a perspective view of the mounting bracket assembly illustrated in FIG. 4;

FIG. 6 is a perspective view of an exterior of a protective shield that is part of the mounting bracket assembly illustrated in FIG. 5;

FIG. 7 is a perspective view of an interior of the protective shield illustrated in FIG. 6;

FIG. 8 is a front perspective view of a polymeric insert of the mounting bracket assembly illustrated in FIG. 5;

FIG. 9 is a rear perspective view of the polymeric insert illustrated in FIG. 8; and

FIG. 10 is another perspective view of the EAC unit illustrated in FIG. 3 attached to a vehicle propulsion system and being protected by a mounting bracket assembly according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

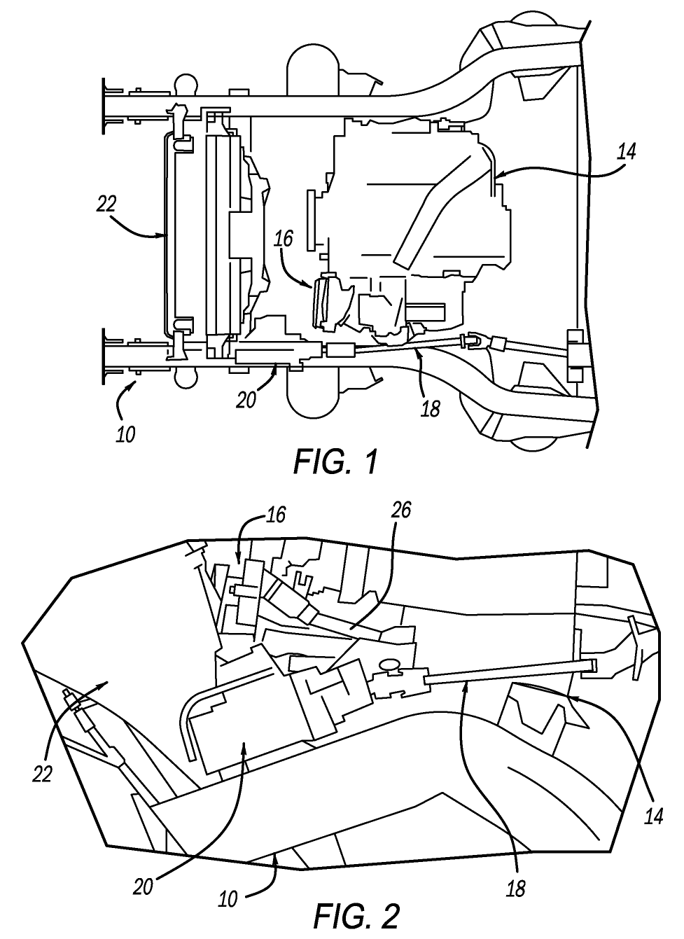

FIG. 1 illustrates a partial view of a frame 10 of a vehicle 12 that includes an internal combustion engine 14 (ICE) having an electric air conditioning compressor unit 16 (EAC) attached thereto. While only ICE 14 is illustrated, it should be understood that vehicle 12 may additionally include components such as a battery pack (not shown) and electric drive modules (not shown) for electrically powering wheels (not shown) of vehicle 12 such that vehicle 12 may be a hybrid-powered vehicle. Additional features of vehicle 12 illustrated in FIG. 1 include a steering column 18 connected to a power steering assembly 20 and a forward HVAC module 22 in communication with the EAC 16 that may include, for example, a condenser (not shown) and fan (not shown) that are part of a vehicle HVAC system, as well as a radiator (not shown) that may circulate a coolant for ICE 14.

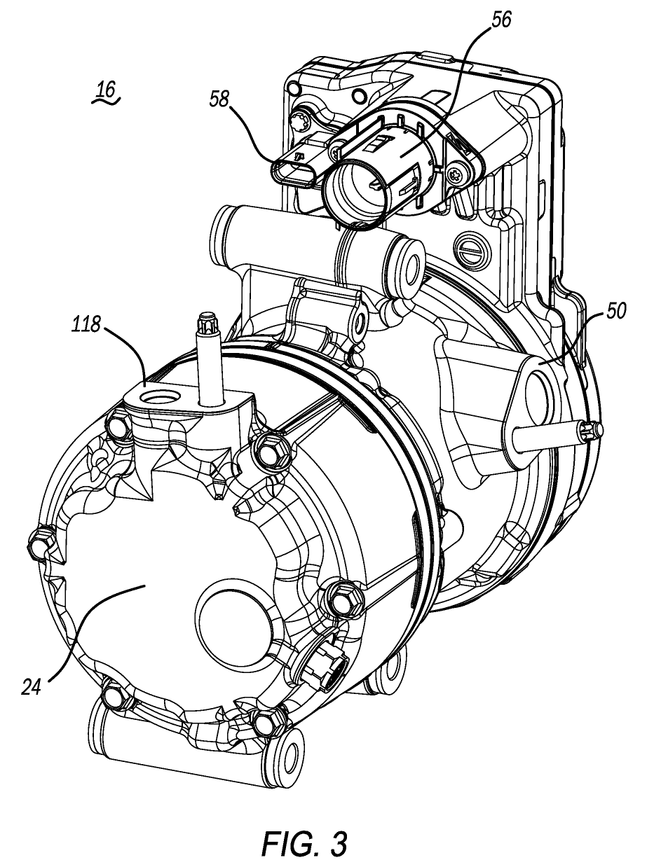

Now referring to FIG. 2 and with continued reference to FIG. 1, it can be seen that when vehicle 12 is involved in a front-end or side collision with an object or another vehicle the forward HVAC module 22, steering column 18, and power steering assembly 20 can be forced in a direction back toward ICE 14 and EAC unit 16. If the forces experienced during the collision event are of sufficient magnitude, contact may occur between these components and the EAC unit 16 that can potentially damage the EAC unit 16. Indeed, forceful contact between the EAC unit 16 and any of the HVAC module 22, steering column 18, and power steering assembly 20 can cause a housing or shell 24 (FIG. 3) of EAC unit 16 to crack or break. If housing or shell 24 breaks, sharp edges can form that could potentially sever a high voltage cable 26 that provides power to EAC unit 16. Alternatively, if cable 26 is not damaged or severed, high-voltage components (not shown) located within housing 24 could be exposed. In either case, it is desirable to avoid damage to EAC unit 16 and cable 26.

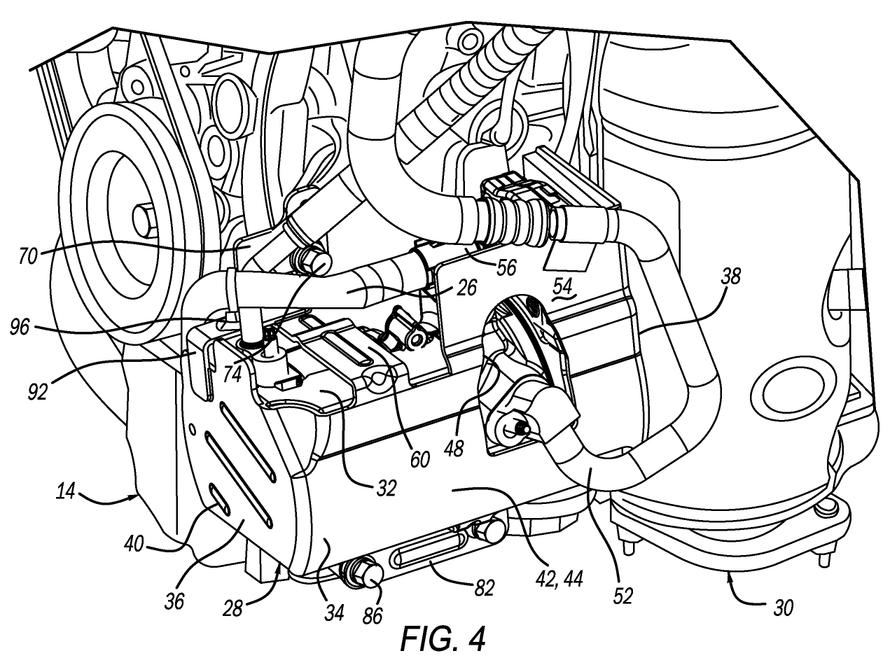

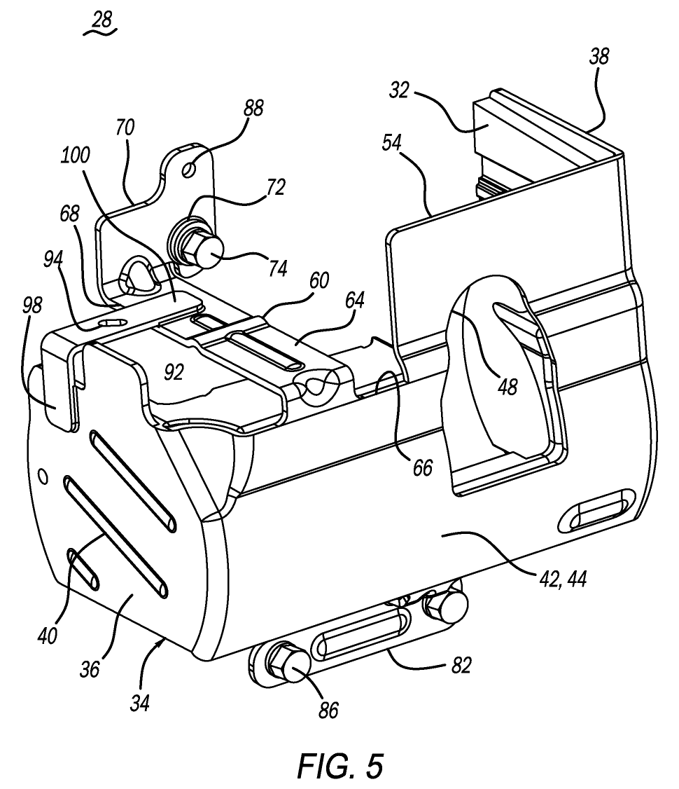

In view of the above, it is desirable to protect EAC unit 16 and cable 26. To this end, the present disclosure provides a mounting bracket assembly 28 that surrounds EAC unit 16 and connects EAC unit 16 to ICE 14, and is designed and configured to protect EAC unit 16 and cable 26 from being damaged during a collision event. EAC unit 16 being attached to ICE 14 using mounting bracket assembly 28 is shown in FIG. 4, and the components of mounting bracket assembly 28 are shown in FIGS. 5-0. In addition, FIG. 4 illustrates the location of EAC unit 16 relative to an exhaust treatment component 30 (e.g., catalytic converter) that receives and treats a high-temperature exhaust generated by ICE 14. Because exhaust treatment component receives and treats the high-temperature exhaust generated by ICE 14, it should be understood that the temperature surrounding exhaust treatment component 30 can also be elevated and potentially affect high-voltage components of the EAC unit 16. It should be understood, therefore, that mounting bracket assembly 28 may include a thermal shielding component or insert 32 that provides thermal insulation for EAC unit 16, as will be described in more detail later.

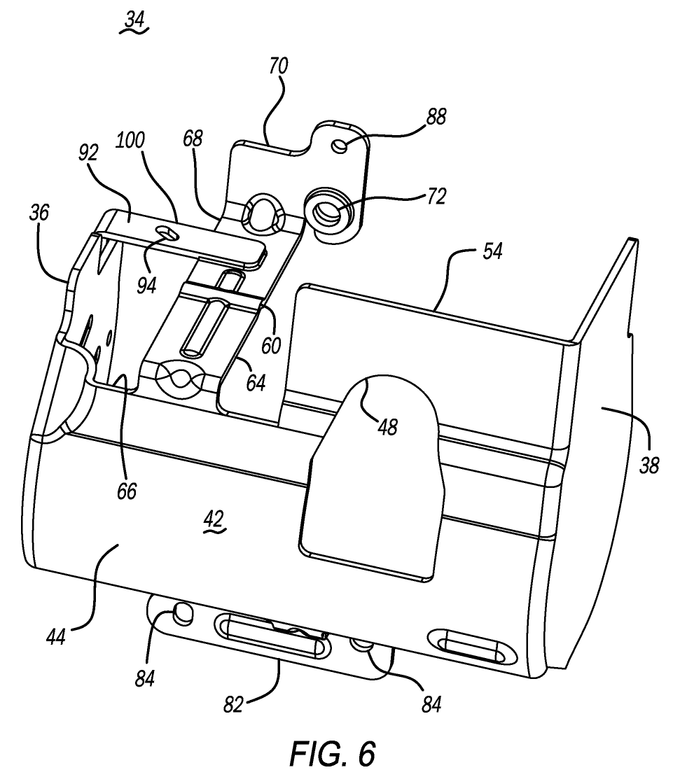

Mounting bracket assembly 28 is best shown in FIGS. 5-9. As can be seen in FIG. 5, mounting bracket assembly 28 includes a protective shield 34 having thermal shielding insert 32 positioned therein. Protective shield 34 may be formed of a rigid material such as a metal material. Example metal materials that may be used to form protective shield 34 include steel, aluminum, titanium, and any other rigid metal material known to one skilled in the art. Protective shield 34 includes a first end 36 that faces a front end of vehicle 10 (i.e., faces in a direction toward HVAC module 22 in FIG. 1) and an opposite second end 38. First and second ends 36 and 38 may include a plurality of ribs 40 for increasing a rigidity thereof so that first and second ends 36 and 38 can withstand greater impact forces thereto.

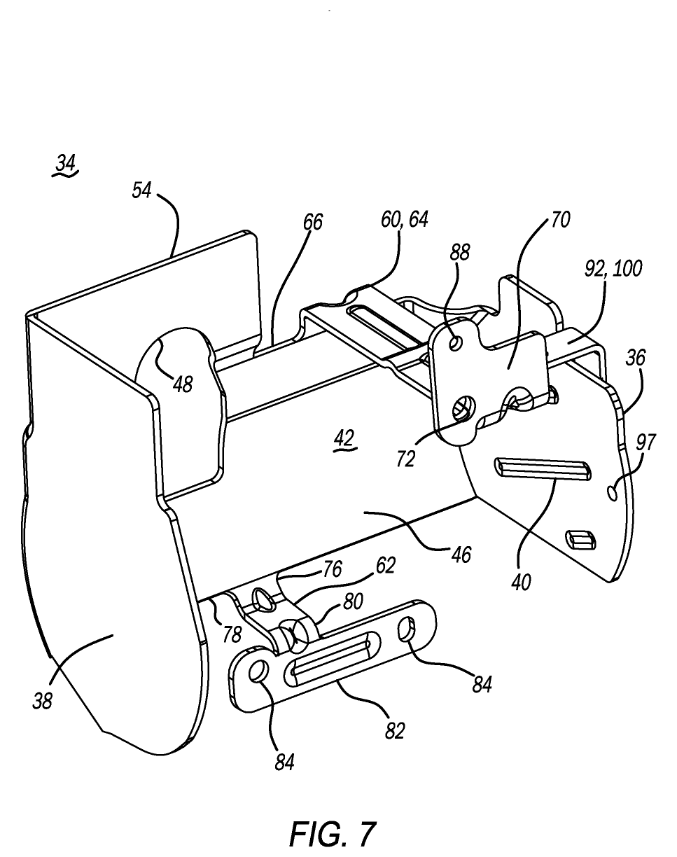

Protective shield 34 includes a primary panel 42 that extends between first end 36 and second end 38. Primary panel 42 includes an exterior surface 44 that faces away from ICE 14, and an interior surface 46 (FIG. 7) that faces ICE 14 and is configured as a seat for thermal shielding insert 32 and EAC unit 16. Primary panel 42 may include an opening 48 that permits a suction port 50 (FIG. 4) of EAC unit 16 to be accessible. Put another way, opening 48 permits a suction hose 52 of the vehicle HVAC system to be attached to suction port 50 of EAC unit 16. A secondary panel 54 that extends upward from primary panel 42 and is connected to second end 38 provides protection for a high-voltage inlet 56 of EAC unit 16 that is configured for attachment with high-voltage cable 26, as well as protection for a low-voltage inlet 58 that is configured for attachment with a low-voltage cable 59.

To attach mounting bracket assembly 28 to ICE 14, mounting bracket assembly 28 includes first and second connection arms 60 and 62. First connection arm 60 includes a first proximate end 64 attached to an upper edge 66 of primary panel 42 and a first distal end 68. First distal end 68 transitions to an upstanding tab 70 having a first through-hole 72 that is configured for receipt of a first fastener 74 such as a bolt that attaches upstanding tab 70 to ICE 14. Second connection arm 62 includes a second proximate end 76 attached to a lower edge 78 of primary panel 42 and a second distal end 80. Second distal end 80 transitions to an elongated tab 82 having a pair of second through holes 84 that are each configured for receipt of a second fastener 86 such as a bolt that attaches elongated tab 70 to ICE 14.

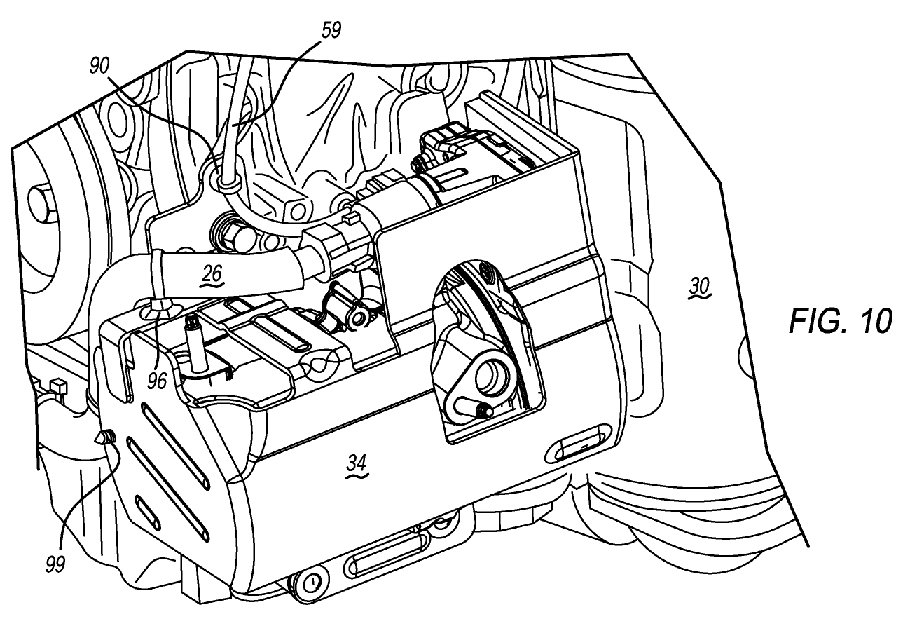

Mounting bracket assembly 28 may also include various features for assisting with orientation of the high-voltage cable 26 and the low-voltage cable 59 relative to ICE 14 and EAC unit 16. For example, upstanding tab 70 may include a first aperture 88 that is configured for receipt of a first clip 90 that is configured for receipt of low-voltage cable 59 (FIG. 10). In addition, an L-shaped strut 92 may be attached to first end 36 of protective shield 42 that includes a second aperture 94 that is configured for receipt of a second clip 96 that is configured for receipt of high-voltage cable 26. Strut 92 includes a first leg 98 attached to first end 36 of protective shield 42 and a second leg 100 arranged orthogonal first leg 98, where the second leg 100 includes the second aperture 94 having the second clip 96 attached thereto. It should also be understood that first end 36 may include a third aperture 97 configured for receipt of a third clip 99 (FIG. 10).

As noted above, EAC unit 16 may be located proximate exhaust treatment component 30 that can elevate the temperature proximate EAC unit 16, and potentially subject the high-voltage components contained in the EAC unit 16 to elevated temperatures that may be undesirable. While protective shield 34 can provide some thermally insulative protection to EAC unit 16, additional thermal protection is provided by a thermal shielding insert 32 that may be provided between protective shield 42 and EAC unit 16. Thermal shielding insert 32 may be formed of a polymeric material such as a polyurethane foam, or some other type of polymeric material or foam that can thermally insulate EAC unit 16 from the elevated temperatures generated during operation of exhaust treatment component 30.

Operation of EAC unit 16 generates noise. Under operating conditions where vehicle 10 is being propelled by ICE 14, the noise generated by EAC unit 16 generally goes unnoticed by occupants of vehicle 10. When vehicle 10 is being electrically propelled (i.e., when ICE 14 is not being used), however, the noise generated by EAC unit 16 during operation thereof may be noticed by the occupants of vehicle 10 because no noise is concurrently being generated by ICE. Thus, in addition to providing thermal insulation to EAC unit 16, it should be understood that thermal shielding insert 32 is also effective at attenuating the noise generated by EAC unit 16 during operation thereof.

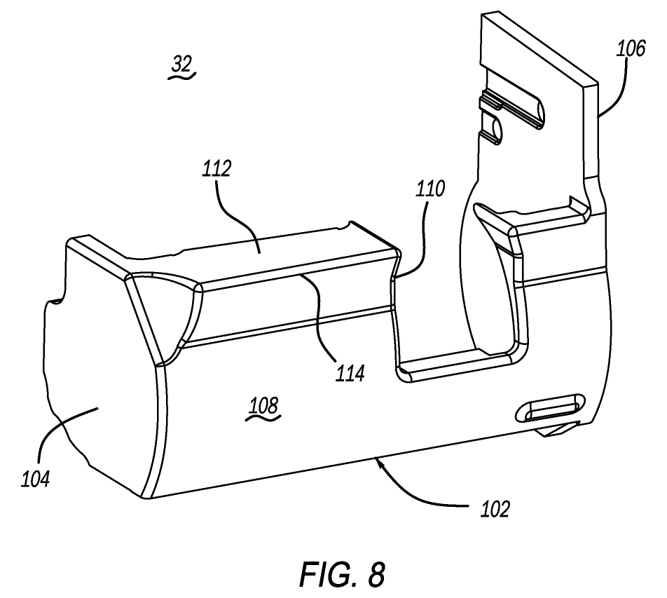

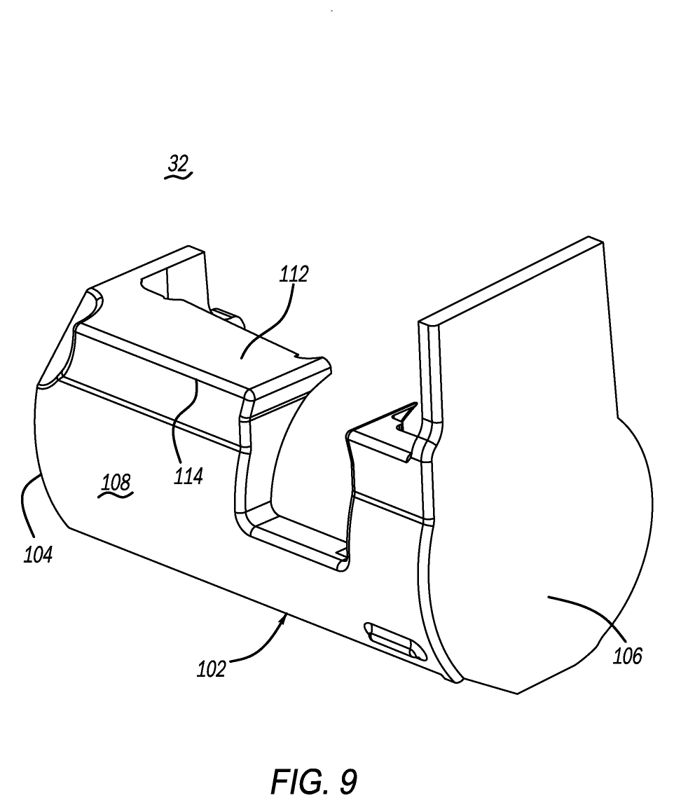

FIGS. 8 and 9 illustrate thermal shielding insert 32 in more detail. As can be seen in FIGS. 8 and 9, thermal shielding insert 32 includes a monolithic body 102 having a first end section 104, an opposite second end section 106, and a primary body 108 extending between the first end section 104 and the second end section 106. Similar to protective shield 42, primary body 108 includes a recess 110 formed therein that is shaped to correspond to that of opening 48. An inwardly extending flange 112 is attached to an upper edge 114 of primary body 108 and first end section 104 that is configured to extend over an upper surface of EAC unit 16. When thermal shielding insert 32 is sandwiched between protective shield 42 and EAC unit 16, the polymeric material of thermal shielding insert 32 may slightly compress to ensure close contact between thermal shielding insert 32 and EAC unit 16, which can further assist with noise attenuation. In addition to attenuating noise, the material of thermal shielding insert 32 may also assist with attenuating vibration of EAC unit 16 during operation thereof and during operation of vehicle 10.

To install EAC unit 16 having mounting bracket assembly 28, EAC unit 16 is first attached to ICE 14 using a plurality of fasteners (not shown). Mounting bracket assembly 28 having thermal shielding insert 32 coupled with protective shield 42 is then located over the EAC unit 16, and first and second fasteners 74 and 86 are used to secure upstanding tab 70 and elongated tab 82 to ICE 14. Next, the first, second, and third clips 90, 96, and 99 are mated with the first, second, and third apertures 88, 94, and 97, respectively, and then the high-voltage cable 26 and low-voltage cable 59 are mated with high-voltage inlet 56 and low-voltage inlet 58, respectively. After mating high- and low-voltage cables 26 and 59 with EAC unit 16, the high-voltage cable 26 and low-voltage cable 59 are mated with the second and third clips 96, 99 and first clip 90, respectively, to properly orient them relative to EAC unit 16 and ICE 14 (FIG. 10). Lastly, suction hose 52 can be mated with suction port 50 and a discharge hose 116 can be mated with a discharge port 118 to complete installation of EAC unit 16 having mounting bracket assembly 28.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a propulsion system;
a high-voltage electric air conditioning compressor (EAC) unit attached to the propulsion system; and
a mounting bracket assembly attached to the EAC unit in a manner where the EAC unit is at least partially sandwiched between the mounting bracket assembly and the propulsion system;
wherein the mounting bracket assembly includes a protective shield that is configured to protect the EAC unit from being damaged during a collision event; and
the mounting bracket assembly includes a polymeric insert that is configured to be sandwiched between the protective shield and the EAC unit.

2. The vehicle according to claim 1, wherein the protective shield and the polymeric insert are each configured to thermally shield the EAC unit.

3. The vehicle according to claim 1, wherein the polymeric insert is configured to attenuate noise generated by the EAC unit.

4. The vehicle according to claim 1, wherein the protective shield includes a first end, an opposite second end, and a primary panel that extends between and is unitary with each of the first end and opposite second end.

5. The vehicle according to claim 4, wherein a first connection arm that is configured to attach the mounting bracket assembly to the propulsion system is attached to an upper edge of the primary panel and a second connection arm that is configured to attach the mounting bracket assembly to the propulsion system is attached to a lower edge of the primary panel.

6. The vehicle according to claim 5, wherein the first connection arm includes an upstanding tab attached thereto having a first through-hole configured for receipt of a first fastener and the second connection arm includes an elongated tab having at least one second through-hole configured for receipt of a second fastener.

7. The vehicle according to claim 6, wherein the upstanding tab includes a first aperture configured for receipt of a first clip.

8. The vehicle according to claim 7, further comprising a strut attached to the first end of the protective shield, the strut having a second aperture configured for receipt of a second clip.

9. The vehicle according to claim 8, wherein the EAC unit includes a high-voltage cable attached thereto and oriented relative to the EAC unit by the second clip, and the EAC unit includes a low-voltage cable attached thereto and oriented relative to the EAC unit by the first clip.

10. The vehicle according to claim 1, wherein the polymeric insert is formed of a polymeric foam.

11. The vehicle according to claim 1, further comprising an exhaust treatment component positioned proximate the EAC unit, wherein the mounting bracket assembly is configured to thermally shield the EAC unit from heat generated by the exhaust treatment component.

12. The vehicle according to claim 1, wherein the protective shield includes an opening and the polymeric insert includes a recess that corresponds to an inlet or an outlet of the EAC unit.

13. The vehicle according to claim 1, wherein the protective shield is formed of a rigid metal material.

14. The vehicle according to claim 1, wherein the polymeric insert includes a first end section, an opposite second end section, and a primary body that extends between and is unitary with each of the first end section and opposite end section.

15. A vehicle comprising:
an internal combustion engine;
an exhaust treatment component in communication with the internal combustion engine;
a high-voltage electric air conditioning compressor (EAC) unit attached to the internal combustion engine at a location proximate the exhaust treatment component; and
a mounting bracket assembly attached to the EAC unit in a manner where the EAC unit is at least partially sandwiched between the mounting bracket assembly and the internal combustion engine;
wherein the mounting bracket assembly includes a protective shield that is configured to protect the EAC unit from being damaged during a vehicle collision event;
the mounting bracket assembly includes a polymeric insert that is configured to be sandwiched between the protective shield and the EAC unit; and
the protective shield and the polymeric insert are each configured to thermally shield the EAC unit from heat generated by the exhaust treatment component, and the polymeric insert is configured to attenuate noise generated by the EAC unit during operation thereof.

16. The vehicle according to claim 15, wherein the protective shield includes a first end, an opposite second end, and a primary panel that extends between and is unitary with each of the first end and opposite second end.

17. The vehicle according to claim 16, wherein a first connection arm that is configured to attach the mounting bracket assembly to the propulsion system is attached to an upper edge of the primary panel and a second connection arm that is configured to attach the mounting bracket assembly to the propulsion system is attached to a lower edge of the primary panel.

18. The vehicle according to claim 17, wherein the first connection arm includes an upstanding tab attached thereto having a first through-hole configured for receipt of a first fastener and the second connection arm includes an elongated tab having at least one second through-hole configured for receipt of a second fastener.

19. The vehicle according to claim 15, wherein the polymeric insert includes a first end section, an opposite second end section, and a primary body that extends between and is unitary with each of the first end section and opposite end section.

20. The vehicle according to claim 15, wherein the polymeric insert is formed of a polymeric foam.
